(19) United States
(12) Patent Application Publication
(10) Pub. No.: US 2025/0353552 A1
(43) Pub. Date: Nov. 20, 2025

(54) Commercial Electric Vehicle Wire Harness Exoskeleton

(71) Applicant: Harbinger Motors Inc., Garden Grove, CA (US)

(72) Inventors: Daniel McCarron, Gardena, CA (US); Phillip John Weicker, Hermosa Beach, CA (US); Alexi Charbonneau, Redondo Beach, CA (US); Kiwoong Nam, Los Angeles, CA (US); Tae Won Park, Cypress, CA (US)

(21) Appl. No.: 19/212,026

(22) Filed: May 19, 2025

Related U.S. Application Data
(60) Provisional application No. 63/649,031, filed on May 17, 2024.

(51) Int. Cl. B62D 21/17; B60R 16/02; B60R 16/08; B62D 21/02; H02G 3/03

(52) U.S. Cl. CPC B62D 21/17; B60R 16/0215; B60R 16/08; B62D 21/02; H02G 3/03

(57) ABSTRACT

Systems and techniques for a wire harness assembly that includes a wire harness subframe supporting a wire harness. The wire harness subframe stabilizes the shape of the wire harness and provides mechanical support. As the subframe stabilizes the shape of the wire harness, the wire harness assembly can be coupled to a vehicle without any additional rework steps.

### CROSS-REFERENCE TO RELATED APPLICATION

This application claims the benefit under 35 U.S.C. § 119 of U.S. Provisional Patent Application No. 63/649,031, entitled “Commercial Vehicle Wire Harness Assembly” and filed on 2024 May 17, which is incorporated herein by reference in its entirety for all purposes.

### BACKGROUND

Due to their size, commercial vehicles typically have extremely bulky wire harnesses. Such wire harnesses are heavy and require periodic attachments. Furthermore, wire harnesses are typically shipped coiled to the place of final assembly, where they are installed in the commercial vehicle. The typical technique of shipping wire harnesses results in a stiff coiled wire harness that is difficult to install in commercial vehicles. Due to the abundance of wires in a typical wire harness, they are difficult to route and typically require heating of the harness to provide the necessary softness to install correctly. Such techniques result in significant logistical challenges for installing wire harnesses and may also result in a harness that lacks the necessary mechanical support.

### SUMMARY

Described herein are systems and techniques for a wire harness assembly that includes an exoskeleton supporting a wire harness. Further described is a commercial vehicle that includes the wire harness assembly. In various embodiments, the commercial vehicle may include a chassis and a wire harness. The wire harness may include a wire harness exoskeleton, coupled to the chassis and a wire harness, coupled to the wire harness exoskeleton.

These and other embodiments are described further below with reference to the figures.

### CLAUSES

Clause 1. A commercial electric vehicle 100 comprising: a chassis 102, comprising: a first frame rail 202A, comprising a first top web 228A; and a second frame rail 202B, comprising a second top web 228B; a wire harness assembly 250, comprising: a wire harness exoskeleton 214, comprising: a first wire harness subframe 252, mechanically coupled to the first top web 228A of the first frame rail 202A and the second top web 228B of the second frame rail 202B and comprising: a first longitudinal brace 216A; a second longitudinal brace 216B; and a first lateral brace 218, coupled to the first longitudinal brace 216A and the second longitudinal brace 216B; and a wire harness 220, coupled to the first wire harness subframe 252.

Clause 2. The commercial electric vehicle 100 of clause 1, wherein the wire harness exoskeleton 214 further comprises: a second wire harness subframe 254, discontiguous from the first wire harness subframe 252 and mechanically coupled to the first top web 228A of the first frame rail 202A and the second top web 228B of the second frame rail 202B, wherein the second wire harness subframe 254 comprises: a third longitudinal brace 234A; a fourth longitudinal brace 234B; and a second lateral brace 236, coupled to the third longitudinal brace 234A and the fourth longitudinal brace 234B, wherein the wire harness 220 is further coupled to the second wire harness subframe 254.

Clause 3. The commercial electric vehicle 100 of clause 1, wherein the first wire harness subframe 252 is mechanically coupled to the first top web 228A and the second top web 228B via mechanical fasteners.

Clause 4. The commercial electric vehicle 100 of clause 1, wherein the wire harness exoskeleton 214 comprises a harness tray 224, and wherein the wire harness 220 is disposed within the harness tray 224.

Clause 5. The commercial electric vehicle 100 of clause 4, wherein the harness tray 224 comprises: a harness tray 224, disposed substantially parallel to the longitudinal brace 216A and/or longitudinal braces 216B; and a tray cross fastener 226, configured to hold the wire harness 220 against the harness tray 224.

Clause 6. The commercial electric vehicle 100 of clause 5, wherein the first wire harness subframe 252 comprises a first longitudinal portion 242 and a second longitudinal portion 244, and wherein the wire harness 220 comprises a wire harness entry 248A disposed within the second longitudinal portion 244.

Clause 7. The commercial electric vehicle 100 of clause 6, wherein the harness tray 224 comprises: a first harness tray portion 224A of a first width, disposed within the first longitudinal portion 242; and a second harness tray portion 224B of a second width different from the first width, disposed within the second longitudinal portion 244.

Clause 8. The commercial electric vehicle 100 of clause 7, wherein the first harness tray portion 224A and the second harness tray portion 224B are discontiguous.

Clause 9. The commercial electric vehicle 100 of clause 4, wherein the wire harness 220 is disposed on a first lateral portion 262 of the wire harness exoskeleton 214, and wherein the wire harness assembly 250 further comprises: a plurality of coolant lines 246, disposed on a second lateral portion 264 of the wire harness exoskeleton 214 opposite the first lateral portion 262.

Clause 10. The commercial electric vehicle 100 of clause 9, wherein the harness tray 224 further comprises: a coolant fastener 240, configured to couple together the plurality of coolant lines 246.

Clause 11. The commercial electric vehicle 100 of clause 9, wherein the wire harness assembly 250 is configured to hold at least a portion of the plurality of coolant lines 246 in a substantially longitudinal manner along a major length of the wire harness exoskeleton 214.

Clause 12. The commercial electric vehicle 100 of clause 11, wherein the wire harness assembly 250 is configured to hold at least a portion of the wire harness 220 in a substantially longitudinal manner along the major length of the wire harness exoskeleton 214.

Clause 13. The commercial electric vehicle 100 of clause 9, wherein the first lateral portion 262 and the second lateral portion 264 of the wire harness exoskeleton 214 are separated by a central portion 266.

Clause 14. The commercial electric vehicle 100 of clause 1, wherein the wire harness exoskeleton 214 is mechanically coupled to the first top web 228A and the second top web 228B via the first lateral brace 218.

Clause 15. The commercial electric vehicle 100 of clause 14, wherein the first lateral brace 218 is disposed vertically above the first top web 228A and the second top web 228B.

Clause 16. The commercial electric vehicle 100 of clause 15, wherein at least a portion of the longitudinal brace 216A and/or the longitudinal brace 216B is disposed vertically in line with or vertically below the first top web 228A and/or the second top web 228B.

Clause 17. The commercial electric vehicle 100 of clause 15, where at least a portion of the wire harness 220 is disposed vertically in line with or vertically below the first top web 228A and/or the second top web 228B.

Clause 18. The commercial electric vehicle 100 of clause 17, wherein the wire harness 220 is disposed between the first frame rail 202A and the second frame rail 202B.

Clause 19. A wire harness assembly 250 comprising: a wire harness exoskeleton 214, configured to receive a wire harness 220 and configured to be mechanically coupled to a first top web 228A of a first frame rail 202A and a second top web 228B of a second frame rail 202B of a commercial electric vehicle 100, the wire harness exoskeleton 214 comprising: a first wire harness subframe 252, comprising: a first longitudinal brace 216A; a second longitudinal brace 216B; and a first lateral brace 218, coupled to the first longitudinal brace 216A and the second longitudinal brace 216B; and a second wire harness subframe 254, discontiguous from the first wire harness subframe 252 and comprising: a third longitudinal brace 234A; a fourth longitudinal brace 234B; and a second lateral brace 236, coupled to the third longitudinal brace 234A and the fourth longitudinal brace 234B.

Clause 20. The wire harness assembly 250 of clause 19, further comprising: the wire harness 220, coupled to the first wire harness subframe 252.

### BRIEF DESCRIPTION OF THE DRAWINGS

FIG. 1 illustrates a commercial vehicle, in accordance with certain embodiments.

FIG. 2 is a perspective view of a commercial vehicle chassis incorporating a wire harness assembly, in accordance with certain embodiments.

FIG. 3 illustrates a top view of a commercial vehicle chassis incorporating a wire harness assembly, in accordance with certain embodiments.

FIG. 4 illustrates a bottom view of a portion of a commercial vehicle chassis incorporating a wire harness assembly, in accordance with certain embodiments.

FIG. 5 illustrates a perspective view of a wire harness assembly, in accordance with certain embodiments.

FIG. 6 illustrates a top representation of a wire harness assembly, in accordance with certain embodiments.

FIGS. 7A and 7B illustrate cross-sectional views of example frame rails, in accordance with certain embodiments.

FIG. 8 is a flowchart illustrating a technique of assembling a wire harness assembly to a commercial vehicle, in accordance with certain embodiments.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

It is to be appreciated that the electric vehicles described herein may include both a left and a right side. In certain figures, for simplicity purposes, element numbers may be provided for only components on one side of the vehicle. However, it is appreciated that such elements, and description provided herein, may also be disposed and/or apply on the other side of the vehicle (e.g., as illustrated in the accompanying figures). In such figures, elements on one lateral side may include an ordinal indicator and a letter (e.g., “longitudinal brace 216A”) while the equivalent elements on the other lateral side may include the same ordinal indicator, but a different letter (e.g., “longitudinal brace 216B”).

It is appreciated that, for the purposes of this disclosure, when an element includes a plurality of similar elements distinguished by a letter following the ordinal indicator (e.g., “216A” and “216B”) and reference is made to only the ordinal indicator itself (e.g., “218”), such a reference is applicable to all the similar elements.

As described herein, “coupled to” may refer to an element that is directly or indirectly connected to another element. Such elements may be coupled via any appropriate permanent (e.g., unremovable without destruction), semi-permanent (e.g., removable through removal of other components), and/or temporary (e.g., directly removable) technique. Elements that are coupled together may be coupled in a fixed or movable relationship.

The vehicle and components described herein may be referred to in a standardized coordinate system. That is, positioning of the components of the vehicle may be defined as longitudinally along the X axis shown in the figures, laterally along the Y axis shown in the figures, and height wise along the Z axis shown in the figures.

### INTRODUCTION

Typically, commercial vehicles have extremely bulky wire harnesses that include a large number of larges bundled together. Such wire harnesses are heavy and require periodic attachments for mechanical support. Such wire harnesses are typically shipped coiled to the place of final assembly, resulting in a stiff wire harness that is difficult to install in commercial vehicles. The wire harnesses will take a “set” from their shipped shape and require rework at the place of assembly to form the wire harness to the proper appropriate shape for installation. Such rework may include heating the wire harness to soften the wire harness to the point where the wire harness can be manipulated into the appropriate shape. Such considerations result in significant logistical challenges for installing wire harnesses and may also result in a harness that lacks the necessary mechanical support.

Described herein are systems and techniques for an exoskeleton supported wire harness. A wire harness may be coupled to an exoskeleton to stabilize the shape of the wire harness and/or for mechanical support. The wire harness assembly, that includes the wire harness and the exoskeleton, may then be shipped to the final point of assembly in a flat packed manner. As the exoskeleton stabilizes the shape of the wire harness, the wire harness assembly may be coupled to the vehicle without any additional steps.

### Vehicle Examples

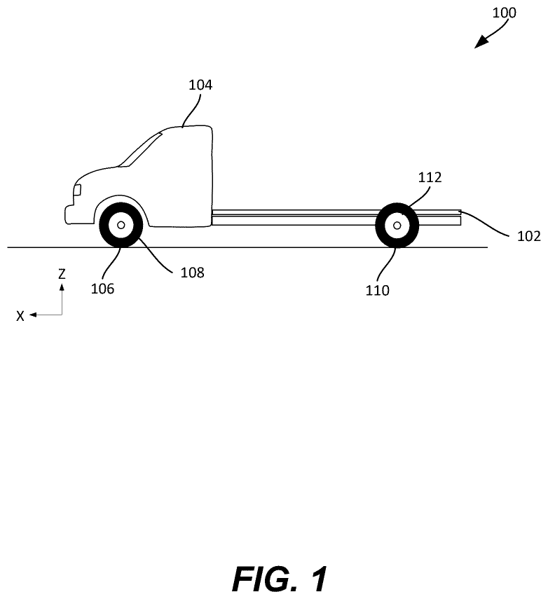

FIG. 1 illustrates a vehicle, in accordance with certain embodiments. FIG. 1 illustrates commercial electric vehicle 100 that includes chassis 102, cab 104, front tire 106, front wheel 108, rear tire 110, and rear wheel 112. In certain embodiments, commercial electric vehicle 100 may be a commercial vehicle. The commercial vehicle may include electric propulsion and/or internal combustion propulsion. The front of commercial electric vehicle 100 may be defined as the forward end (e.g., the end of commercial electric vehicle 100 that is closer to front wheel 108 than rear wheel 112) and the rear of commercial electric vehicle 100 may be defined as the rearward end (e.g., the end of commercial electric vehicle 100 that is closer to rear wheel 112 than front wheel 108).

Commercial electric vehicle 100 may represent any type of commercial vehicle, such as a vehicle with an integrated cargo volume, (e.g., a delivery van or a box truck), a flatbed truck, a pickup truck, a truck with an enclosed cargo box, a towing vehicle, and/or any other such commercial vehicle. Chassis 102 may be any type of appropriate chassis, such as a ladder frame, unibody, monocoque, semi-monocoque, and/or other such type of chassis that may allow for commercial electric vehicle 100 to provide load-carrying and/or towing ability. Cab 104 may be coupled to chassis 102 and may be configured to house one or more occupants, such as a driver. Cab 104 may provide for controls for operating commercial electric vehicle 100.

Though not illustrated in FIG. 1, commercial electric vehicle 100 may additionally include one or more of a flatbed, truck bed, cargo container, cabin, and/or other compartment for carrying loads and/or performing tasks. In certain embodiments, commercial electric vehicle 100 may be powered by one or more electric drive units (e.g., electric motors and drivetrains for the electric motors) that are mounted in various portions of commercial electric vehicle 100. For example, commercial electric vehicle 100 may mount one or more electric motors in front of tire 110 and wheel 112, within the frame rails of 102, and/or within another portion of commercial electric vehicle 100.

### Wire Harness Assembly Examples

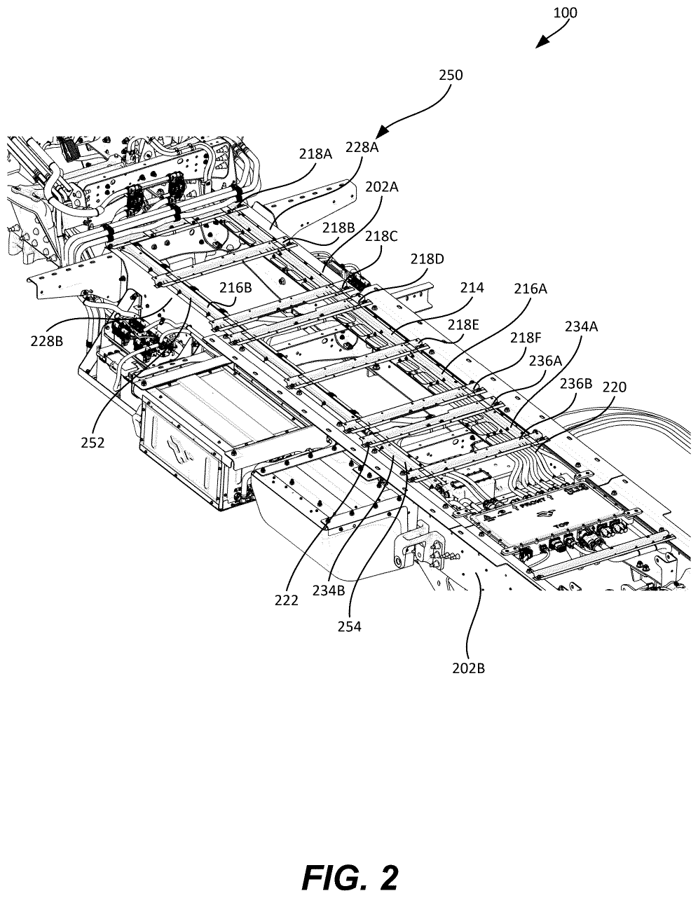

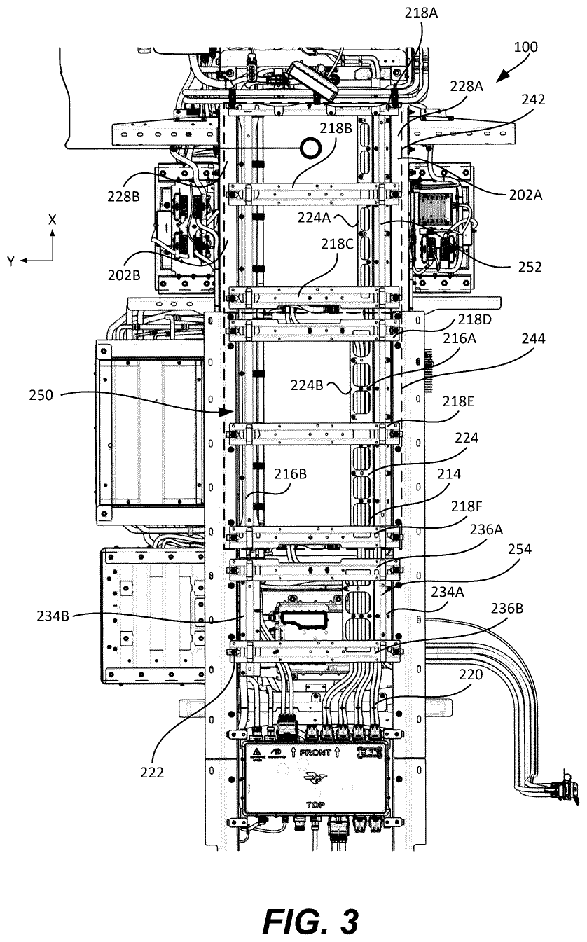

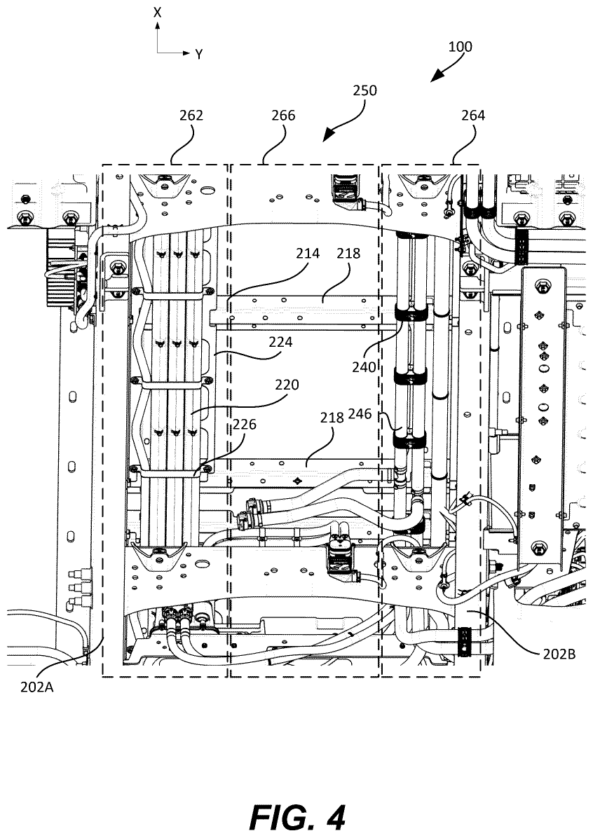

FIG. 2 is a perspective view of a commercial vehicle chassis incorporating a wire harness assembly, in accordance with certain embodiments. FIG. 3 illustrates a top view of a commercial vehicle chassis incorporating a wire harness assembly, in accordance with certain embodiments. FIG. 4 illustrates a bottom view of a portion of a commercial vehicle chassis incorporating a wire harness assembly, in accordance with certain embodiments.

FIGS. 2-4 illustrate commercial electric vehicle 100 that includes frame rails 202 and wire harness assembly 250. Wire harness assembly 250 may include wire harness exoskeleton 214 and wire harness 220.

Wire harness 220 may include one or more wires with electrical connections (e.g., stripped wires and/or connectors) on one or both ends of each wire. The wires of wire harness 220 may be configured to provide electrical signals (e.g., power and/or data) between one or more components of vehicle 200. In certain embodiments, wire harness 220 may include one or more wire bundles which may include one or more wires coupled together within an insulator. Individual wires or portions of the wire bundle may split off based on the location of the connection for the individual wires or wire bundles. Thus, wire harness 220 may be formed with a specific geometry.

Wire harness 220 may couple to wire harness exoskeleton 214. Wire harness 220 may couple to wire harness exoskeleton 214 via any appropriate technique, such as via adhesives, mechanical fasteners (e.g., nuts and bolts, tabs, pins, hook and loop, and/or other such techniques), press fits, and/or other such techniques. Such techniques may be further illustrated in FIG. 4.

In various embodiments, wire harness 220 may be decoupled from other portions of vehicle 200. That is, wire harness 220 may only be directly connected to wire harness exoskeleton 214 and may not mate to other portions of vehicle 200 except through electrical connections (e.g., through electrical connectors). Thus, if wire harness 220 is decoupled from all mating connectors and wire harness exoskeleton 214 is decoupled from other portions of vehicle 200, wire harness assembly 250 may be removed as a unit from vehicle 200.

Wire harness exoskeleton 214 may include a frame structure. Wire harness 220 may be coupled to such a frame structure. The frame structure may provide mechanical support for wire harness 220 and may prevent wire harness 220 from deforming (e.g., due to transport). The frame structure of wire harness exoskeleton 214 may include one or a plurality of subframes, such as first wire harness subframe 252 and second wire harness subframe 254. First wire harness subframe 252 and second wire harness subframe 254 may be discontiguous. That is, first wire harness subframe 252 may not be directly connected to second wire harness subframe 254. Instead, each of first wire harness subframe 252 and second wire harness subframe 254 may be separately coupled to first frame rail 202A and/or second frame rail 202B of chassis 102 and wire harness 220, as well as other components such as coolant lines 246, may be coupled to one or both of first wire harness subframe 252 and second wire harness subframe 254.

Each of first wire harness subframe 252 and/or second wire harness subframe 254 may include one or more one or more braces. For example, first wire harness subframe 252 may include longitudinal brace 216A, longitudinal brace 216B, and lateral braces 218A-F. Second wire harness subframe 254 may include third longitudinal brace 234A, fourth longitudinal brace 234B, and lateral braces 236A and 236B.

One or more of longitudinal brace 216A, longitudinal brace 216B, lateral braces 218A-F, third longitudinal brace 234A, fourth longitudinal brace 234B, and lateral braces 236A and 236B may, in the example of FIGS. 2-4, be stamped or extruded metal forms. The longitudinal and lateral braces of a subframe may be coupled together via mechanical fasteners (e.g., bolts or screws), adhesives, welding, and/or other such techniques. For example, longitudinal brace 216A and longitudinal brace 216B may be coupled to lateral braces 218A-F via mechanical fasteners (e.g., bolts or screws), adhesives, welding, and/or other such techniques and third longitudinal brace 234A and fourth longitudinal brace 234B may be coupled to lateral braces 236A and 236B via mechanical fasteners (e.g., bolts or screws), adhesives, welding, and/or other such techniques. Other embodiments may include other numbers and/or configurations of braces and/or may include other features such as castings, composite forms, wire frames, and/or other such structures.

Wire harness exoskeleton 214 (e.g., first wire harness subframe 252 and second wire harness subframe 254) may be coupled to ladder frame 202 of vehicle 200 via one or a plurality of couplings 222.

Coupling 222 may be a permanent or semi-permanent coupling (e.g., may be non-removable or removable). Coupling 222 may be, for example, one or more of mechanical fasteners, adhesives, welding, and/or other such couplings. In certain embodiments, wire harness exoskeleton 214, for a portion thereof, may be coupled to the top of ladder frame 202. For example, one or more of lateral braces 218A-F may be disposed above (e.g., higher on the Z axis) longitudinal brace 216A and/or longitudinal brace 216B. One or more of lateral braces 236A and 236B may be disposed above third longitudinal brace 234A and/or fourth longitudinal brace 234B. The one or more of lateral braces 218A-F and/or lateral braces 236A and 236B may be configured to couple to a top web (e.g., top web 228) of first frame rail 202A and/or second frame rail 202B via coupling 222.

In various such embodiments, while one or more of lateral braces 218A-F may be configured to couple to first top web 228A and/or second top web 228B of first frame rail 202A and/or second frame rail 202B, respectively, at least a portion of first longitudinal brace 216A and/or second longitudinal brace 216B may be disposed vertically in line with (e.g., on the same level) or vertically below first top web 228A and/or second top web 228B (e.g., for embodiments where lateral braces 218A-F are disposed above longitudinal brace 216A and/or longitudinal brace 216B). Similarly, while one or more of lateral braces 236A and 236B may be configured to couple to first top web 228A and/or second top web 228B, at least a portion of third longitudinal brace 234A and/or fourth longitudinal brace 234B may be disposed vertically in line with (e.g., on the same level) or vertically below first top web 228A and/or second top web 228B.

As wire harness 220, coolant lines 246, and/or other such components may be coupled to a bottom portion of wire harness exoskeleton 214, such a configuration may dispose wire harness 220, plurality of coolant lines 246, and/or other such components below the first top web 228A and/or second top web 228B and, thus, between first frame rail 202A and second frame rail 202B. Such a configuration may allow for more compact packaging and provide protection to wire harness 220, coolant lines 246, and/or other such components. Furthermore, such a position may allow for wire harness 220, coolant lines 246, and/or other such components to be disposed proximate to (e.g., within 2 feet) of existing vehicle systems.

Furthermore, portions of wire harness exoskeleton 214 coupling together a plurality of frame rails (e.g., first frame rail 202A and second frame rail 202B) may impart additional stiffness to chassis 102 of commercial electric vehicle 100. Additionally or alternatively, wire harness exoskeleton 214 may also receive additional stiffness from coupling to chassis 102. Wire harness exoskeleton 214 may also include compliance, such as bending or torsional compliance, into its structure to accommodate bending or torsional flexing of ladder frame 202.

While a ladder frame is described as a type of chassis that may receive wire harness assembly 250, it is appreciated that other embodiments may allow for wire harness assembly 250 to couple to other types of chassis, such as unibody, monocoque, skateboard, and/or other such chassis types.

Coupling 222 may be any type of fastener (e.g., clip, rivet, bolt, adhesive, and/or any other such fastener) configured to couple wire harness exoskeleton 214 to ladder frame 202 (e.g., first frame rail 202A and second frame rail 202B). Coupling wire harness exoskeleton 214 to a plurality of frame rails allows for greater mechanical support for wire harness exoskeleton 214, increasing the mechanical support that wire harness exoskeleton 214 is able to offer wire harness 220.

In certain embodiments, wire harness 220 or a portion thereof may be disposed within or coupled to harness tray 224, which may be configured to hold one or more wires or wire bundles and allow for proper routing of the wires. Harness tray 224 may be coupled to one or more longitudinal and/or lateral braces of wire harness exoskeleton 214. In certain embodiments, harness tray 224 may be configured to prevent the wires and/or wire bundles from twisting, kinking, and/or otherwise misrouting in a manner that “shortens” the wire or wire bundle as such “shortening” may result in the wires and/or wire bundles being unable to connect to their corresponding connector on the vehicle side.

Harness tray 224 may be disposed on any portion of wire harness exoskeleton 214, including, for example, below lateral braces 218 and/or longitudinal braces 234. Accordingly, harness tray 224 may, similar to longitudinal braces 216 and/or longitudinal braces 234, be disposed in line with or below portions of ladder frame 202, such as below first top web 228A and/or second top web 228B.

Various wire harness subframes, such as first wire harness subframe 252, may include a plurality of different longitudinal portions. For example, first wire harness subframe 252 may include first longitudinal portion 242 and second longitudinal portion 244. Second longitudinal portion 244 may be disposed behind (e.g., longitudinally toward the rear of commercial electric vehicle 100) first longitudinal portion 242. In certain embodiments, wire harness 220 disposed within first longitudinal portion 242 may, for example, be of a first thickness and/or include a first number of wires while wire harness 220 disposed within second longitudinal portion 244 may be of a second thickness and/or include a second number of wires.

Wire harness 220 may be of different thicknesses and/or include a different number of wires at different longitudinal points of wire harness exoskeleton 214. Accordingly, harness tray 224 may include first harness tray portion 224A and second harness tray portion 224B, as well as other harness tray portions. First harness tray portion 224A, disposed within first longitudinal portion 242, and second harness tray portion 224B, disposed within second longitudinal portion 244, may be different lateral widths (e.g., different widths along the y-axis) to accommodate the different thicknesses or wire counts of wire harness 220 along different portions of its length.

Wires and/or wire bundles disposed within harness tray 224 (e.g., wire harness 220) may be securely held to harness tray 224 by tray cross fastener 226. Tray cross fastener 226 may be brackets, frames, extrusions, castings, ties, hook and loops, wires, string, and/or other such items that secure wires and/or wire bundles of harness 220 to harness tray 224. In various embodiments, a plurality of tray cross fastener 226 may be disposed along the length of harness tray 224 to provide support for the wires and/or wire bundles.

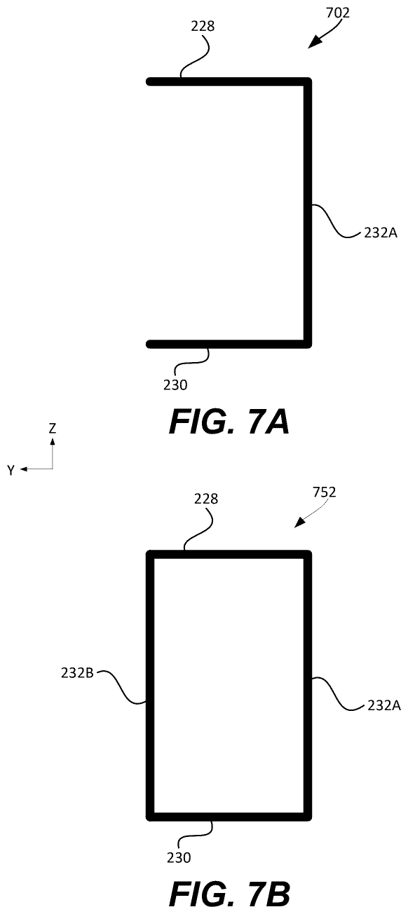

Accordingly, wire harness 220 may be secured to wire harness exoskeleton 214. Wire harness exoskeleton 214 may then be secured to vehicle 200 along portions of ladder frame 202 of vehicle 200. Referring to FIGS. 7A and 7B, FIGS. 7A and 7B illustrate cross-sectional views of example frame rails, in accordance with certain embodiments. FIG. 7A illustrates a cross-sectional view of a C-channel ladder frame 702 and FIG. 7B illustrates a cross-sectional view of a boxed ladder frame 752.

C-channel ladder frame 702 may include top web 228, bottom web 230, and side web 232A. Top web 228 may be disposed on a top portion of C-channel ladder frame 702 and may extend laterally. Bottom web 230 may be disposed on a bottom portion of C-channel ladder frame 702 and may extend laterally. Side web 232A may vertically connect top web 228 and bottom web 230.

Boxed ladder frame 752 may include top web 228, bottom web 230, side web 232A, and side web 232B. Top web 228, bottom web 230, and side web 232A may be similar to that of the corresponding elements of C-channel ladder frame 702. Side web 232B may vertically connect top web 228 and bottom web 230 and may be disposed opposite that of side web 232A.

Referring back to FIGS. 2-4, wire harness exoskeleton 214 may provide support for wire harness 220 and reduce or eliminate the need to couple portions of wire harness 220 to, for example, side web 232 of ladder frame 202 of commercial electric vehicle 100. Thus, wire harness exoskeleton 214 may be mounted to top web 228 of ladder frame 202. Typically, vehicle systems are generally not coupled to top web 228 and, thus, wire harness exoskeleton 214 may more effectively utilize the surface area of the chassis (e.g., ladder frame 202) of commercial electric vehicle 100 and allow other components to use critical surface area on ladder frame 202 (e.g., along side web 232 of ladder frame 202).

Wire harness exoskeleton 214 may, additionally or alternatively, provide support for coolant lines 246. Coolant lines 246 also run longitudinally along wire harness exoskeleton 214 or a portion thereof. As an example, wire harness exoskeleton 214 may include a plurality of different lateral portions, such as first lateral portion 262, second lateral portion 264, and central portion 266. First lateral portion 262 may be disposed along a first lateral side (e.g., towards the left or right hand side of wire harness exoskeleton 214) while second lateral portion 264 may be disposed along a second lateral side opposite the first lateral side. Central portion 266 may be the central lateral portion disposed between first lateral portion 262 and second lateral portion 264.

As an example, wire harness 220 may be disposed within first lateral portion 262 and coolant lines 246 may be disposed within second lateral portion 264 opposite first lateral portion 262. One or both of wire harness 220 and coolant lines 246 may be coupled to wire harness exoskeleton 214 in a substantially linear manner. That is, the majority of the length of wire harness 220 and/or coolant lines 246 may run within 20 degrees of longitudinal while coupled to wire harness exoskeleton 214.

Coolant lines 246 may be coupled to portions of wire harness exoskeleton 214 (e.g., longitudinal and/or lateral braces) via coolant fastener 240. Coolant fastener 240 may include any appropriate fastener, such as brackets, frames, extrusions, castings, ties, hook and loops, wires, string, and/or other such items. Coolant fastener 240 may couple together a plurality of coolant lines 246 and/or couple one or a plurality of coolant lines 246 to portions of wire harness exoskeleton 214. Central portion 266 may be disposed between first lateral portion 262 and second lateral portion 264 and, thus, separates first lateral portion 262 and second lateral portion 264 and provides separation between wire harness 220 and coolant lines 246.

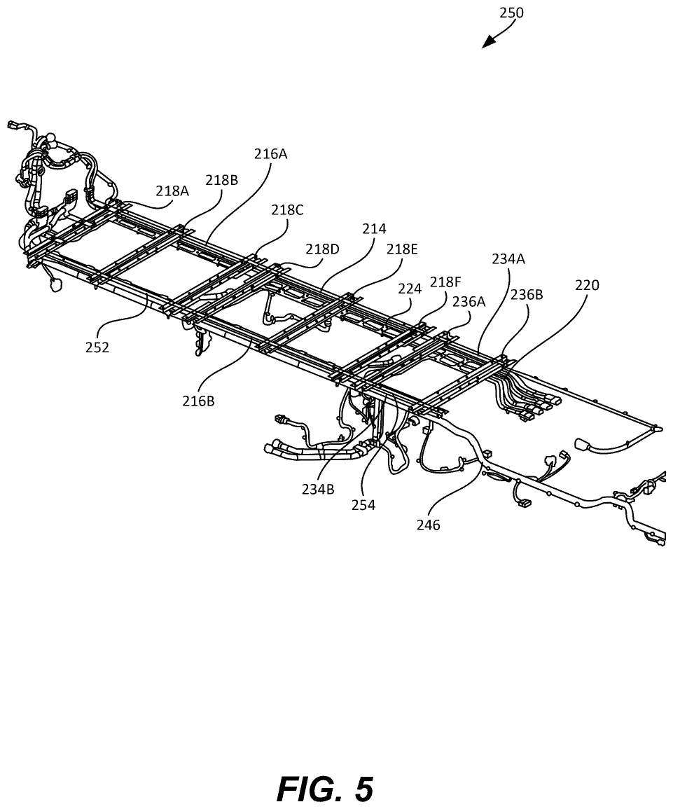

FIG. 5 illustrates a perspective view of a wire harness assembly, in accordance with certain embodiments. FIG. 5 illustrates wire harness assembly 250 that includes wire harness exoskeleton 214, wire harness 220, and coolant lines 246 as described herein. Wire harness 220 and coolant lines 246 may be disposed on opposing sides of wire harness assembly 250. Accordingly, wire harness exoskeleton 214 may be configured to support a plurality of decoupled wire harnesses, coolant lines, and/or other such components.

As shown, wire harness exoskeleton 214 may include first wire harness subframe 252 and second wire harness subframe 254, in accordance with the disclosure herein. First wire harness subframe 252 and second wire harness subframe 254 may be discontiguous subframes. First wire harness subframe 252 may include various longitudinal braces 216 and lateral braces 218 as described herein and second wire harness subframe 254 may include various longitudinal braces 234 and lateral braces 236 as described herein.

In certain embodiments, harness tray 224 may be coupled to one or both of first wire harness subframe 252 and second wire harness subframe 254. In other embodiments, first wire harness subframe 252 and second wire harness subframe 254 may include their own separate harness trays. Certain embodiments may couple certain wires, wire harnesses, coolant lines, and/or other components without trays or other such subcomponents.

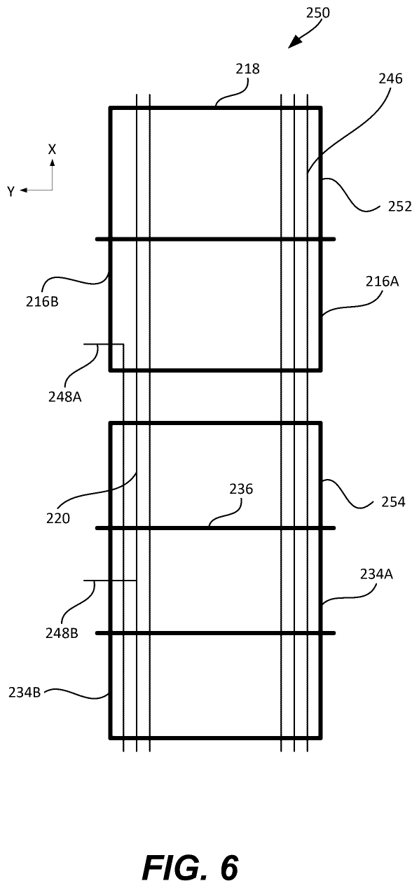

FIG. 6 illustrates a top representation of a wire harness assembly, in accordance with certain embodiments. FIG. 6 illustrates an abstraction of wire harness assembly 250 that includes discontiguous first wire harness subframe 252 and second wire harness subframe 254. Variously, first wire harness subframe 252 may include longitudinal brace 216A and longitudinal brace 216B coupled together with one or more lateral braces 218 and second wire harness subframe 254 may include third longitudinal brace 234A and fourth longitudinal brace 234B coupled together with one or more lateral braces 236.

Wire harness 220, or portions thereof, may span the length of wire harness assembly 250, including along the length (e.g., longitudinal distance) of first wire harness subframe 252 and second wire harness subframe 254. In certain embodiments, wire harness 220 may include a plurality of wires and certain wires may enter or exit along portions of the length of wire harness exoskeleton 214. Thus, for example, wire harness entry 248A and wire harness exit 248B may be disposed along portions of wire harness 220.

Wire harness entry 248A may be disposed within second longitudinal portion 244. Wire harness entry 248A may be a wire with a connector that connects to various electrical systems of commercial electric vehicle 100, such as batteries, controllers, and/or other such components.

Wire harness exit 248B may be disposed in the same portion of wire harness exoskeleton 214 as wire harness entry 248A or in another portion, such as within the longitudinal portion of wire harness exoskeleton 214 that includes second wire harness subframe 254. Wire harness exit 248B may be a wire with a connector that terminates to various electrical systems of commercial electric vehicle 100, such as batteries, controllers, and/or other such components.

### Process Examples

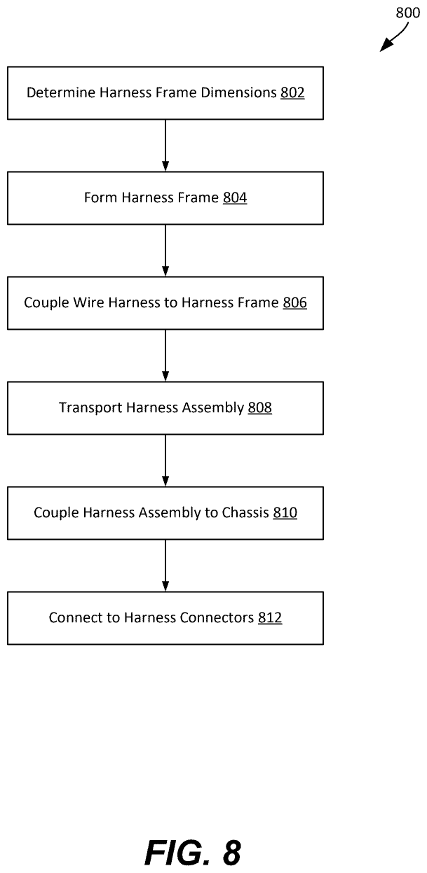

FIG. 8 is a flowchart illustrating a technique of assembling a wire harness assembly to a commercial vehicle, in accordance with certain embodiments. FIG. 8 illustrates technique 800, which may be a technique for utilizing a wire harness assembly with a wire harness subframe in the assembly of a commercial vehicle.

In 802, the dimensions of the wire harness exoskeleton may be determined, including the dimensions of any harness subframes. For example, a wire harness assembly for a certain class of commercial vehicle may include frame rails of a fixed measurement. Based on the measurement, the measurements of the lateral braces may be determined.

Similarly, various commercial vehicle classes may include different lengths and the lengths of the wire harness skeleton, or the harness subframes thereof, may be adjusted based on the length of the commercial vehicle. Thus, for example, the first harness subframe may be a subframe of a fixed length and the second harness subframe may be a subframe of differing lengths, the length of which is selected based on the length of the vehicle, or vice versa. Such a configuration may provide for manufacturing flexibility.

In 804, the wire harness exoskeleton may be formed according to the dimensions determined in 802. Forming of the wire harness exoskeleton may include coupling together stampings and/or extrusions, casting, baking, stamping, extruding, and/or other such techniques that allow for the creation of the wire harness exoskeleton.

In 806, the wire harness and/or other components may be coupled to the wire harness exoskeleton formed in 804. Coupling of the wire harness to the wire harness exoskeleton may include securing the wire harness exoskeleton according to the techniques described herein, such as disposing the wire harness or portion thereof within a harness tray and/or securing the wire harness to the wire harness exoskeleton via one or more fasteners.

In 808, the wire harness assembly may be transported to a point of assembly. In various embodiments, as the wire harness may be coupled to wire harness tray to form the wire harness assembly, the wire harness assembly may be flat packed or shipped in another space efficient manner. The wire harness assembly may be shipped in a manner that allows for the wire harness assembly to be coupled to the vehicle without additional rework steps. Thus, for example, the wire harness assembly may be received and placed atop the ladder frame of the vehicle and coupled with fasteners without further rework.

In 810, the wire harness assembly may be coupled to the chassis of the vehicle via mechanical fasteners, adhesives, welding, and/or other such techniques. The wire harness assembly may be coupled to a portion of the chassis as described herein.

In 812, after the wire harness assembly has been coupled to the chassis, other wires (e.g., wires that are directly coupled to the vehicle) may be connected to the wire harness by, for example, connecting mating connectors to the wire harness connectors.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A commercial electric vehicle 100 comprising:
a chassis 102, comprising:
a first frame rail 202A, comprising a first top web 228A; and
a second frame rail 202B, comprising a second top web 228B;
a wire harness assembly 250, comprising:
a wire harness exoskeleton 214, comprising:
a first wire harness subframe 252, mechanically coupled to the first top web 228A of the first frame rail 202A and the second top web 228B of the second frame rail 202B and comprising:
a first longitudinal brace 216A;
a second longitudinal brace 216B; and
a first lateral brace 218, coupled to the first longitudinal brace 216A and the second longitudinal brace 216B; and
a wire harness 220, coupled to the first wire harness subframe 252.

2. The commercial electric vehicle 100 of claim 1, wherein the wire harness exoskeleton 214 further comprises:
a second wire harness subframe 254, discontiguous from the first wire harness subframe 252 and mechanically coupled to the first top web 228A of the first frame rail 202A and the second top web 228B of the second frame rail 202B, wherein the second wire harness subframe 254 comprises:
a third longitudinal brace 234A;
a fourth longitudinal brace 234B; and
a second lateral brace 236, coupled to the third longitudinal brace 234A and the fourth longitudinal brace 234B, wherein the wire harness 220 is further coupled to the second wire harness subframe 254.

3. The commercial electric vehicle 100 of claim 1, wherein the first wire harness subframe 252 is mechanically coupled to the first top web 228A and the second top web 228B via mechanical fasteners.

4. The commercial electric vehicle 100 of claim 1, wherein the wire harness exoskeleton 214 comprises a harness tray 224, and wherein the wire harness 220 is disposed within the harness tray 224.

5. The commercial electric vehicle 100 of claim 4, wherein the harness tray 224 comprises:
a harness tray 224, disposed substantially parallel to the longitudinal brace 216A and/or longitudinal braces 216B; and
a tray cross fastener 226, configured to hold the wire harness 220 against the harness tray 224.

6. The commercial electric vehicle 100 of claim 5, wherein the first wire harness subframe 252 comprises a first longitudinal portion 242 and a second longitudinal portion 244, and wherein the wire harness 220 comprises a wire harness entry 248A disposed within the second longitudinal portion 244.

7. The commercial electric vehicle 100 of claim 6, wherein the harness tray 224 comprises:
a first harness tray portion 224A of a first width, disposed within the first longitudinal portion 242; and
a second harness tray portion 224B of a second width different from the first width, disposed within the second longitudinal portion 244.

8. The commercial electric vehicle 100 of claim 7, wherein the first harness tray portion 224A and the second harness tray portion 224B are discontiguous.

9. The commercial electric vehicle 100 of claim 4, wherein the wire harness 220 is disposed on a first lateral portion 262 of the wire harness exoskeleton 214, and wherein the wire harness assembly 250 further comprises:
a plurality of coolant lines 246, disposed on a second lateral portion 264 of the wire harness exoskeleton 214 opposite the first lateral portion 262.

10. The commercial electric vehicle 100 of claim 9, wherein the harness tray 224 further comprises:
a coolant fastener 240, configured to couple together the plurality of coolant lines 246.

11. The commercial electric vehicle 100 of claim 9, wherein the wire harness assembly 250 is configured to hold at least a portion of the plurality of coolant lines 246 in a substantially longitudinal manner along a major length of the wire harness exoskeleton 214.

12. The commercial electric vehicle 100 of claim 11, wherein the wire harness assembly 250 is configured to hold at least a portion of the wire harness 220 in a substantially longitudinal manner along the major length of the wire harness exoskeleton 214.

13. The commercial electric vehicle 100 of claim 9, wherein the first lateral portion 262 and the second lateral portion 264 of the wire harness exoskeleton 214 are separated by a central portion 266.

14. The commercial electric vehicle 100 of claim 1, wherein the wire harness exoskeleton 214 is mechanically coupled to the first top web 228A and the second top web 228B via the first lateral brace 218.

15. The commercial electric vehicle 100 of claim 14, wherein the first lateral brace 218 is disposed vertically above the first top web 228A and the second top web 228B.

16. The commercial electric vehicle 100 of claim 15, wherein at least a portion of the longitudinal brace 216A and/or the longitudinal brace 216B is disposed vertically in line with or vertically below the first top web 228A and/or the second top web 228B.

17. The commercial electric vehicle 100 of claim 15, where at least a portion of the wire harness 220 is disposed vertically in line with or vertically below the first top web 228A and/or the second top web 228B.

18. The commercial electric vehicle 100 of claim 17, wherein the wire harness 220 is disposed between the first frame rail 202A and the second frame rail 202B.

19. A wire harness assembly 250 comprising:
a wire harness exoskeleton 214, configured to receive a wire harness 220 and configured to be mechanically coupled to a first top web 228A of a first frame rail 202A and a second top web 228B of a second frame rail 202B of a commercial electric vehicle 100, the wire harness exoskeleton 214 comprising:
a first wire harness subframe 252, comprising:
a first longitudinal brace 216A;
a second longitudinal brace 216B; and
a first lateral brace 218, coupled to the first longitudinal brace 216A and the second longitudinal brace 216B; and
a second wire harness subframe 254, discontiguous from the first wire harness subframe 252 and comprising:
a third longitudinal brace 234A;
a fourth longitudinal brace 234B; and
a second lateral brace 236, coupled to the third longitudinal brace 234A and the fourth longitudinal brace 234B.

20. The wire harness assembly 250 of claim 19, further comprising:
the wire harness 220, coupled to the first wire harness subframe 252.
